(19) United States
(12) Patent Application Publication
(10) Pub. No.: US 2020/0177067 A1
(43) Pub. Date: Jun. 4, 2020

(54) MOTOR

(71) Applicant: NIDEC CORPORATION, Kyoto (JP)

(72) Inventors: Yoshihisa OKUHATA, Kanagawa (JP); Kunihiro KAJITA, Kanagawa (JP); Mika KONAGAYA, Kanagawa (JP); Yosuke ITO, Kanagawa (JP)

(21) Appl. No.: 16/631,441

(22) PCT Filed: Jul. 25, 2018
(86) PCT No.: PCT/JP2018/027802

§ 371 Date: Jan. 15, 2020

(30) Foreign Application Priority Data
Jul. 28, 2017 (JP) 2017-147111

(51) Int. Cl. H02K 24/00; H02K 7/08; H02K 11/00; H02K 11/225; H02K 11/33

(52) U.S. Cl. CPC H02K 24/00; H02K 7/083; H02K 11/33; H02K 11/225; H02K 11/0094

(57) ABSTRACT

In one aspect of a motor of the present invention, a housing has a stator housing portion and an inverter housing portion, and is a single member. A rotation detection unit detects the rotation of a rotor. A sensor wiring electrically connects the rotation detection unit and an inverter. The stator housing portion has a bottomed tubular shape having a circumferential wall that is open to one side in the axial direction and a bottom wall that is provided at an end on the other side in the axial direction of the circumferential wall. An output end of a motor shaft of the rotor protrudes from an opening of the circumferential wall toward the one side in the axial direction. The rotation detection unit is arranged on the bottom wall, and the sensor wiring passes through the inside of the bottom wall.

### CROSS-REFERENCE TO RELATED APPLICATIONS

This is the U.S. national stage of application No. PCT/JP2018/027802, filed on Jul. 25, 2018, and priority under 35 U.S.C. § 119(a) and 35 U.S.C. § 365(b) is claimed from Japanese Application No. 2017-147111, filed on Jul. 28, 2017.

### FIELD OF THE INVENTION

The present invention relates to a motor.

### BACKGROUND

A motor driving apparatus and a vehicle have been known. A motor drive unit, which is an example of the motor driving apparatus, includes a first housing portion, a second housing portion, a first cover portion, and a second cover portion. The first housing portion houses a motor and a winding switcher. The second housing portion houses an inverter. The first housing portion includes a motor housing portion and a winding switcher housing portion. A non-load side of the motor housing portion is open and is provided with a resolver housing portion in which a resolver is disposed. The first cover portion is attached to the resolver housing portion by a screw member.

When a wiring extending from a resolver is connected to an inverter in a motor having a stator housing portion and an inverter housing portion, a route for routing the wiring needs to be complicated, or the wiring needs to be led out to the outside of the motor. For this reason, there is room for improvement in terms of improving the ease of assembly by making it easy to route the wiring of the resolver.

### SUMMARY

One aspect of a motor of the present invention includes: a rotor having a motor shaft arranged along a central axis that extends in one direction; a stator opposing the rotor with a gap in a radial direction; an inverter electrically connected to the stator; a housing having a stator housing portion that houses the stator and an inverter housing portion that houses the inverter; a rotation detection unit detecting a rotation of the rotor; and a sensor wiring electrically connecting the rotation detection unit and the inverter. The housing is a single member. The stator housing portion has a bottomed tubular shape having a circumferential wall that is open on one side in an axial direction and a bottom wall provided at an end on another side in the axial direction of the circumferential wall. An output end of the motor shaft protrudes from an opening of the circumferential wall toward the one side in the axial direction. The rotation detection unit is arranged on the bottom wall. The sensor wiring passes through an inside of the bottom wall.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating a motor according to the present invention;

FIG. 2 is a perspective view illustrating the motor according to the present invention;

FIG. 3 is a view illustrating the motor according to the present embodiment and is a cross-sectional view taken along line III-III of FIG. 1;

FIG. 4 is a cross-sectional view illustrating a part of the motor according to the present embodiment;

FIG. 5 is a view illustrating a part of the motor according to the present embodiment and is a partial cross-sectional view taken along line V-V of FIG. 3; and

FIG. 6 is a view illustrating a part of the motor according to the present embodiment and is a top view illustrating a partition wall through-hole as viewed from an inverter housing portion.

### DETAILED DESCRIPTION

A Z-axis direction illustrated in each drawing is a vertical direction Z in which a positive side is an upper side and a negative side is a lower side. A Y-axis direction is a direction parallel to a central axis J extending in one direction illustrated in each drawing and is a direction orthogonal to the vertical direction Z. In the following description, the direction parallel to the central axis J, that is, the Y-axis direction will be simply referred to as an “axial direction Y”. In addition, a positive side in the axial direction Y will be referred to as “one side in the axial direction”, and a negative side in the axial direction Y will be referred to as the “other side in the axial direction”. The X-axis direction illustrated in each drawing is a direction orthogonal to both the axial direction Y and the vertical direction Z. In the following description, the X-axis direction will be referred to as a “width direction X”. In addition, a positive side in the width direction X will be referred to as “one side in the width direction”, and a negative side in the width direction X will be referred to as the “other side in the width direction”.

In addition, a radial direction about the central axis J will be simply referred to as the “radial direction”, and a circumferential direction about the central axis J will be simply referred to as a “circumferential direction”. Note that the vertical direction, the upper side, and the lower side are simply names for describing a relative positional relationship of each portion, and an actual arrangement relationship or the like may be an arrangement relationship other than the arrangement relationship indicated by these names.

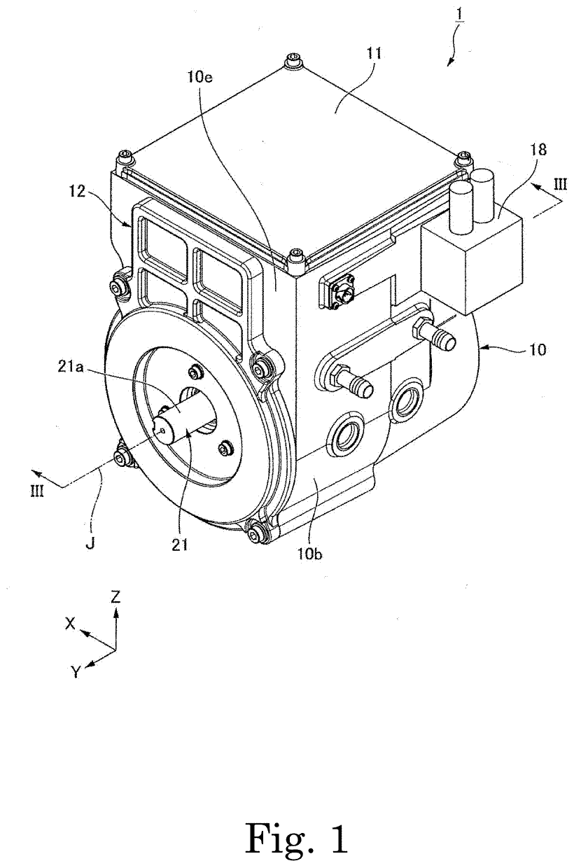

As illustrated in FIGS. 1 to 3, a motor 1 of the present embodiment includes a housing 10, a lid 11, a cover member 12, a sensor cover 13, a rotor 20 having a motor shaft 21 arranged along the central axis J, a stator 30, an inverter unit 50, a connector 18, and a rotation detection unit 70.

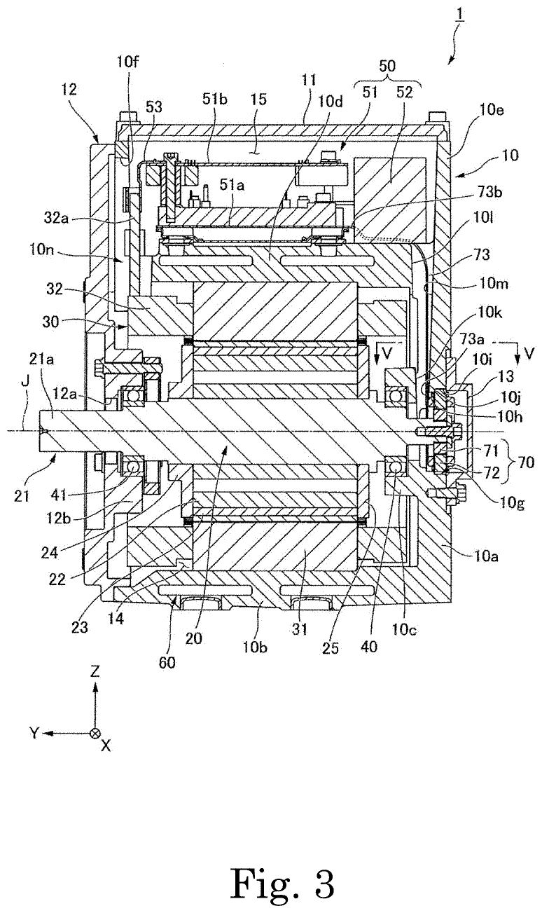

As illustrated in FIG. 3, the housing 10 houses the rotor 20, the stator 30, the rotation detection unit 70, and the inverter unit 50. The housing 10 is a single member. The housing 10 is manufactured by sand casting, for example. The housing 10 includes a circumferential wall 10b, a bottom wall 10a, a first bearing holding portion 10c, and a rectangular tube portion 10e.

The circumferential wall 10b has a tubular shape surrounding the rotor 20 and the stator 30 on the radially outer side of the rotor 20 and the stator 30. In the present embodiment, the circumferential wall 10b has a substantially cylindrical shape centered on the central axis J. The circumferential wall 10b is open on the one side in the axial direction. The circumferential wall 10b has a cooling unit 60 that cools the stator 30 and the inverter unit 50. The cooling unit 60 has a cooling flow path and a coolant flowing inside the cooling flow path.

The bottom wall 10a is provided at an end on the other side in the axial direction of the circumferential wall 10b. The bottom wall 10a closes the other side in the axial direction of the circumferential wall 10b. The bottom wall 10a and the circumferential wall 10b constitute a stator housing portion 14. That is, the housing 10 has the bottomed tubular stator housing portion 14 having the circumferential wall 10b and the bottom wall 10a.

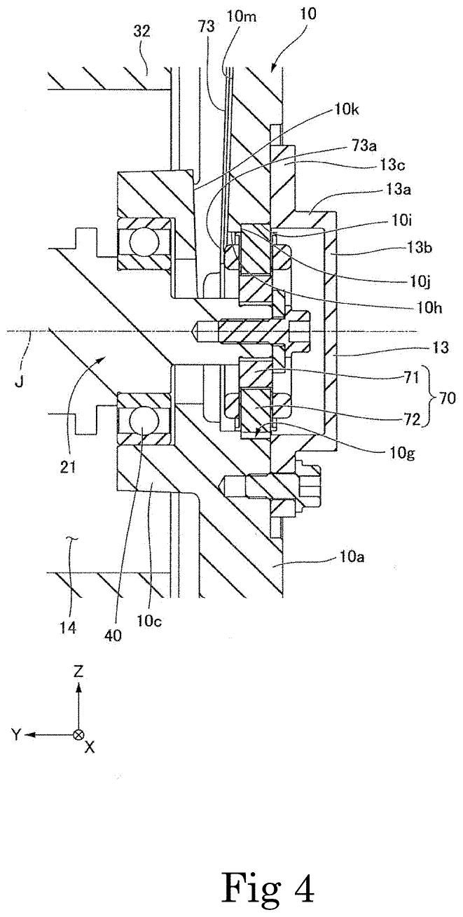

The bottom wall 10a has a sensor housing portion 10g that penetrates the bottom wall 10a in the axial direction Y as illustrated in FIGS. 3 and 4. The sensor housing portion 10g has a circular shape centered on the central axis J, for example, as viewed along the axial direction Y. The sensor housing portion 10g has a multi-stage circular hole shape whose inner diameter differs in each portion in the axial direction Y. The sensor housing portion 10g includes a small-diameter portion 10h, a large-diameter portion 10i, and a step portion 10j. The small-diameter portion 10h is a portion on one side in the axial direction of the sensor housing portion 10g. The large-diameter portion 10i is a portion on the other side in the axial direction of the sensor housing portion 10g. An inner diameter of the large-diameter portion 10i is larger than an inner diameter of the small-diameter portion 10h. The step portion 10j connects an end on the other side in the axial direction of the small-diameter portion 10h and an end on the one side in the axial direction of the large-diameter portion 10i. The step portion 10j is an annular surface that faces the other side in the axial direction. The step portion 10j is a plane perpendicular to the central axis J.

The first bearing holding portion 10c has a tubular shape protruding from the bottom wall 10a toward the one side in the axial direction. More specifically, the first bearing holding portion 10c has a cylindrical shape protruding from a circumferential edge of the sensor housing portion 10g on a surface on the one side in the axial direction of the bottom wall 10a to the one side in the axial direction. The first bearing holding portion 10c holds a first bearing 40 that supports the motor shaft 21 on the other side in the axial direction of a rotor core 22 to be described later.

As illustrated in FIGS. 3 to 5, the first bearing holding portion 10c has a wiring passage hole 10k that penetrates the first bearing holding portion 10c in the radial direction. The wiring passage hole 10k is arranged in an upper portion of the first bearing holding portion 10c. The wiring passage hole 10k penetrates a circumferential wall of the first bearing holding portion 10c in the vertical direction Z. The wiring passage hole 10k is arranged at a center portion of the first bearing holding portion 10c in the width direction X. In the present embodiment, the center portion of the first bearing holding portion 10c in the width direction X includes a portion of the first bearing holding portion 10c in the width direction X is the same as the central axis J. The wiring passage hole 10k is arranged at an end on the other side in the axial direction of the first bearing holding portion 10c. A lower end of the wiring passage hole 10k is connected to the sensor housing portion 10g.

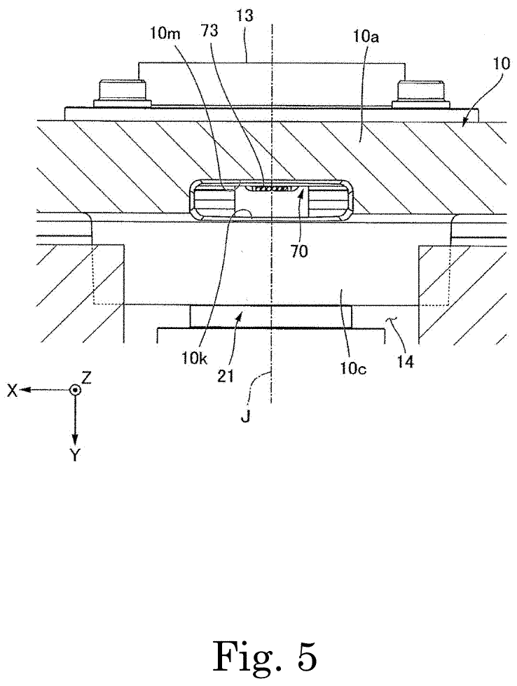

As illustrated in FIG. 5, the wiring passage hole 10k has a rectangular shape when the first bearing holding portion 10c is viewed from the upper side to the lower side in the vertical direction Z. That is, the wiring passage hole 10k is a rectangular hole having a length in the width direction X longer than a length in the axial direction Y in the top view of the first bearing holding portion 10c illustrated in FIG. 5. In addition, in this top view, a corner of an inner surface of the wiring passage hole 10k has a concave curved surface. The corner of the inner surface of the wiring passage hole 10k is a connecting portion between a surface facing the axial direction Y and a surface facing the width direction X of the inner surface of the wiring passage hole 10k. The number of corners of the inner surface of the wiring passage hole 10k is four.

In FIGS. 3 to 5, the length of the wiring passage hole 10k in the axial direction Y gradually increases from an inner circumferential surface to an outer circumferential surface of a circumferential wall (that is, upward) in an upper portion of the circumferential wall of the first bearing holding portion 10c. In FIG. 5, a length of the wiring passage hole 10k in the width direction X gradually increases from the inner circumferential surface to the outer circumferential surface of the circumferential wall in the upper portion of the circumferential wall of the first bearing holding portion 10c. Note that the wiring passage hole 10k may have an oval shape in this top view. In this case, the wiring passage hole 10k has an oval hole shape in which the length in the width direction X is longer than the length in the axial direction Y in the top view.

As illustrated in FIGS. 3 to 6, the bottom wall 10a has a groove 10m that is recessed from one side to the other side in the axial direction. The groove 10m is recessed from a surface facing the one side in the axial direction of the bottom wall 10a toward the other side in the axial direction. The groove 10m extends on the surface on the one side in the axial direction of the bottom wall 10a in a direction connecting the rotation detection unit 70 and the inverter 51. In the present embodiment, the groove 10m extends upward from the sensor housing portion 10g. The groove 10m is arranged at the center portion of the bottom wall 10a in the width direction X.

A lower end of the groove 10m is connected to the wiring passage hole 10k. The groove 10m is connected to the sensor housing portion 10g through the wiring passage hole 10k. An upper end of the groove 10m is connected to a partition wall through-hole 10l of a partition wall 10d to be described later. The groove 10m is connected to the inverter housing portion 15 through the partition wall through-hole 10l. The wiring passage hole 10k, the groove 10m, and the partition wall through-hole 10l are arranged continuously in the radial direction. The wiring passage hole 10k, the groove 10m, and the partition wall through-hole 10l are arranged in this order from the lower side to the upper side in the vertical direction Z and are connected to each other.

The groove 10m has a groove bottom surface and a pair of groove side surfaces. The groove bottom surface is a portion, which faces the one side in the axial direction, of an inner surface constituting the groove 10m. The groove side surface is a portion, which faces the width direction X, of the inner surface constituting the groove 10m. The pair of groove side surfaces are arranged to oppose each other with a gap in the width direction X. The groove side surface connects an end of the groove bottom surface in the width direction X and the surface on the one side in the axial direction of the bottom wall 10a.

In the cross-sectional view illustrated in FIG. 5, a length of the groove bottom surface in the width direction X is longer than a length of the groove side surface in the axial direction Y. In addition, a corner of the inner surface of the groove 10m has a concave curved surface shape in this cross-sectional view. The corner of the inner surface of the groove 10m is a connecting portion between the groove bottom surface and the groove side surface of the inner surface of the groove 10m. The number of corners of the inner surface of the groove 10m is two. A depth (groove depth) of the groove 10m in the axial direction Y gradually increases upward from the sensor housing portion 10g. That is, the length of the groove side surface of the groove 10m in the axial direction Y gradually increases upward from the wiring passage hole 10k.

As illustrated in FIGS. 1 to 3, the rectangular tube portion 10e has a rectangular tube shape extending upward from the circumferential wall 10b. The rectangular tube portion 10e is open upward. In the present embodiment, the rectangular tube portion 10e has, for example, a square tube shape. A wall on the other side in the axial direction among walls constituting the rectangular tube portion 10e is connected to an upper end of the bottom wall 10a. The rectangular tube portion 10e has a through-hole 10f that penetrates a wall on the one side in the axial direction among the walls constituting the rectangular tube portion 10e in the axial direction Y. A lower end of the through-hole 10f is connected to an opening on the one side in the axial direction of the circumferential wall 10b. The rectangular tube portion 10e and the circumferential wall 10b constitute an inverter housing portion 15. That is, the housing 10 has the inverter housing portion 15.

The inverter housing portion 15 is located on the radially outer side of the stator housing portion 14. In the present embodiment, the inverter housing portion 15 is located above the stator housing portion 14 in the vertical direction Z orthogonal to the axial direction Y. The stator housing portion 14 and the inverter housing portion 15 are partitioned in the vertical direction Z by a partition wall 10d. The partition wall 10d is an upper portion of the circumferential wall 10b. That is, the circumferential wall 10b includes the partition wall 10d that partitions the stator housing portion 14 and the inverter housing portion 15. The partition wall 10d is located between the stator housing portion 14 and the inverter housing portion 15.

A dimension of the partition wall 10d in the vertical direction Z increases as a distance from the central axis J increases in the width direction X orthogonal to both the axial direction Y and the vertical direction Z. That is, the dimension of the partition wall 10d in the vertical direction Z is the smallest at a center portion where a position in the width direction X is the same as the central axis J, and increases as being separated from the center portion toward both sides in the width direction X.

As illustrated in FIG. 3, the partition wall 10d has the partition wall through-hole 10l that penetrates the partition wall 10d in the radial direction. The partition wall through-hole 10l penetrates the partition wall 10d in the vertical direction Z. The partition wall through-hole 101 is arranged at an end on the other side in the axial direction of the partition wall 10d. The partition wall through-hole 10l is arranged at a center portion of the partition wall 10d in the width direction X.

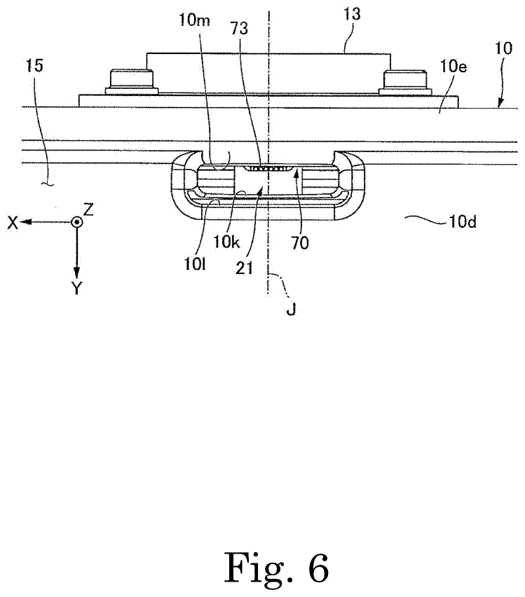

As illustrated in FIG. 6, the partition wall through-hole 10l has a rectangular shape as viewed from the inverter housing portion 15. That is, the partition wall through-hole 10l has a rectangular hole shape in which a length in the width direction X is longer than a length in the axial direction Y as the partition wall 10d is viewed from the upper side to the lower side in the vertical direction Z in FIG. 6. In addition, a corner of an inner surface of the partition wall through-hole 10l has a concave curved surface shape in this top view. The corner of the inner surface of the partition wall through-hole 10l is a connecting portion between a surface facing the axial direction Y and a surface facing the width direction X of the inner surface of the partition wall through-hole 10l. The number of corners of the inner surface of the partition wall through-hole 10l is four. Note that FIG. 6 does not illustrate the lid 11 and the capacitor 52 to be described later.

The length of the partition wall through-hole 10l in the axial direction Y gradually increases from a lower surface to an upper surface of the partition wall 10d (that is, upward). The length of the partition wall through-hole 10l in the width direction X gradually increases from the lower surface to the upper surface of the partition wall 10d.

Note that the partition wall through-hole 10l may have an oval shape as viewed from the inverter housing portion 15. In this case, the partition wall through-hole 101 has an oval hole shape in which the length in the width direction X is longer than the length in the axial direction Y as the partition wall 10d is viewed from the upper side to the lower side in the vertical direction Z.

In FIG. 3, at the end on the one side in the axial direction of the housing 10, the motor 1 has a housing opening 10n through which at least a part of the stator 30, the end on the one side in the axial direction of the partition wall 10d, and at least a part of the inverter housing portion 15 are exposed. A coil wire 32a extending from the stator 30 is arranged inside the housing opening 10n. That is, the coil wire 32a is arranged at the end on the one side in the axial direction of the housing 10. The coil wire 32a will be described later separately.

As illustrated in FIGS. 1 to 3, the lid 11 has a plate shape whose plate surface is orthogonal to the vertical direction Z. The lid 11 is fixed to an upper end of the rectangular tube portion 10e. The lid 11 closes an upper opening of the rectangular tube portion 10e.

The cover member 12 has a plate shape whose plate surface is orthogonal to the axial direction Y. The cover member 12 is fixed to surfaces on the one side in the axial direction of the circumferential wall 10b and the rectangular tube portion 10e. The cover member 12 closes an opening on the one side in the axial direction of the circumferential wall 10b and the through-hole 10f. The cover member 12 covers the housing opening 10n from the one side in the axial direction.

In FIG. 3, the cover member 12 has an output shaft hole 12a that penetrates the cover member 12 in the axial direction Y. The output shaft hole 12a has, for example, a circular shape that passes through the central axis J. The cover member 12 includes a second bearing holding portion 12b that protrudes from a circumferential edge of the output shaft hole 12a on a surface on the other side in the axial direction of the cover member 12 to the other side in the axial direction. The second bearing holding portion 12b holds a second bearing 41 that supports the motor shaft 21 on the one side in the axial direction of the rotor core 22 to be described later.

The sensor cover 13 is fixed to a surface on the other side in the axial direction of the bottom wall 10a. That is, the sensor cover 13 is provided on the bottom wall 10a. The sensor cover 13 covers and closes an opening on the other side in the axial direction of the sensor housing portion 10g. The sensor cover 13 covers the rotation detection unit 70 from the other side in the axial direction.

The rotor 20 includes the motor shaft 21, includes rotor core 22, a magnet 23, a first end plate 24, and a second end plate 25. The motor shaft 21 is rotatably supported by the first bearing 40 and the second bearing 41 at the both sides in the axial direction. That is, an end on the other side in the axial direction of the motor shaft 21 is rotatably supported by the first bearing 40. A portion of the motor shaft 21 on the one side in the axial direction is rotatably supported by the second bearing 41.

An end on the one side in the axial direction of the motor shaft 21 protrudes from the opening on the one side in the axial direction of the circumferential wall 10b toward the one side in the axial direction. The end on the one side in the axial direction of the motor shaft 21 passes through the output shaft hole 12a and protrudes to the one side in the axial direction from the cover member 12. In the present embodiment, the end on the one side in the axial direction of the motor shaft 21 will be referred to as an output end 21a. A reduction gear or the like (not illustrated) is connected to the output end 21a. An end on the other side in the axial direction of the motor shaft 21 is inserted into the sensor housing portion 10g.

The rotor core 22 is fixed to an outer circumferential surface of the motor shaft 21. The magnet 23 is inserted into a hole that penetrates the rotor core 22 provided in the rotor core 22 in the axial direction Y. The first end plate 24 and the second end plate 25 have an annular plate shape that expands in the radial direction. The first end plate 24 and the second end plate 25 sandwich the rotor core 22 in the axial direction Y in the state of being in contact with the rotor core 22. The first end plate 24 and the second end plate 25 press the magnet 23, which has been inserted into the hole of the rotor core 22, from both sides in the axial direction.

The stator 30 opposes the rotor 20 with a gap in the radial direction. The stator 30 is arranged on the radially outer side of the rotor 20. The stator 30 is housed in the stator housing portion 14. The stator 30 includes a stator core 31 and a plurality of coils 32 attached to the stator core 31. The stator core 31 has an annular shape centered on the central axis J. An outer circumferential surface of the stator core 31 is fixed to an inner circumferential surface of the circumferential wall 10b. The stator core 31 opposes the outer side in the radial direction of the rotor core 22 with a gap.

The inverter unit 50 controls power to be supplied to the stator 30. The inverter unit 50 includes an inverter 51 and a capacitor 52. That is, the motor 1 includes an inverter 51 and a capacitor 52. The inverter 51 is housed in the inverter housing portion 15. The inverter 51 includes a first circuit board 51a and a second circuit board 51b. The first circuit board 51a and the second circuit board 51b have a plate shape whose plate surface is orthogonal to the vertical direction Z. The second circuit board 51b is arranged to be separated from the first circuit board 51a. The first circuit board 51a and the second circuit board 51b are electrically connected. A coil wire 32a is connected to the first circuit board 51a via a connector terminal 53. The connector terminal 53 is provided at the end on the one side in the axial direction of the inverter 51. As a result, the inverter 51 is electrically connected to the stator 30.

The coil wire 32a extends upward from the coil 32 of the stator 30. The coil wire 32a passes through the end on the one side in the axial direction of the partition wall 10d and is connected to the inverter 51. The coil wire 32a extends from the stator housing portion 14 to the inverter housing portion 15 through the one side in the axial direction of the partition wall 10d.

The coil wire 32a includes three three-phase wiring bundles in which a plurality of coil wires are bundled for each of a U phase, a V phase, and a W phase. That is, the coil wire 32a is the three-phase coil wire 32a. In addition, the coil wire 32a includes a neutral-point wiring bundle in which a plurality of neutral-point coil wires are bundled. The neutral-point wiring bundle is the wiring bundle configured to connect the three three-phase wiring bundles by star connection.

The capacitor 52 has a rectangular parallelepiped shape that is long in the width direction X. The capacitor 52 is housed in the inverter housing portion 15. The capacitor 52 is arranged on the other side in the axial direction of the inverter 51. That is, the inverter 51 and the capacitor 52 are arranged side by side in the axial direction Y in the inverter housing portion 15. The capacitor 52 is electrically connected to the inverter 51. The capacitor 52 is fixed to the upper surface of the partition wall 10d. The capacitor 52 is in contact with the partition wall 10d.

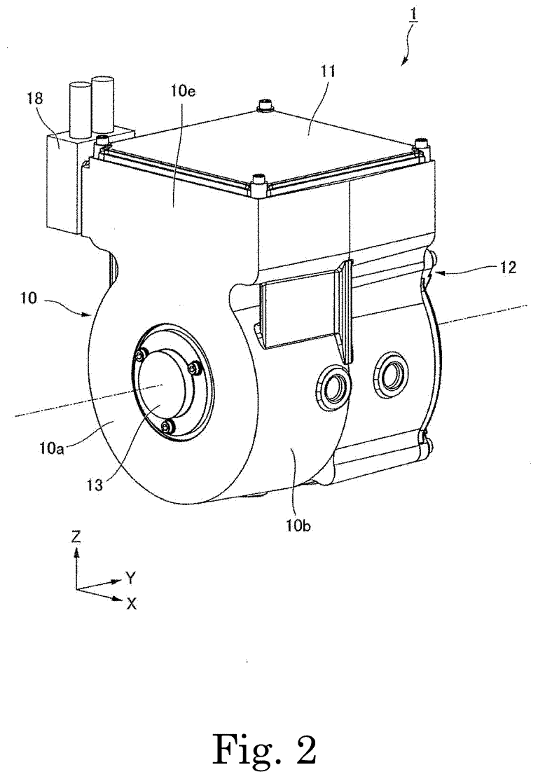

As illustrated in FIGS. 1 and 2, the connector 18 is provided on the surface on the other side in the width direction of the rectangular tube portion 10e. An external power supply (not illustrated) is connected to the connector 18. Power is supplied to the inverter unit 50 from the external power supply connected to the connector 18.

The rotation detection unit 70 detects the rotation of the rotor 20. The rotation detection unit 70 detects, for example, a rotation angle position of the motor shaft 21 in the circumferential direction with respect to the housing 10. In this case, the rotation detection unit 70 may be rephrased as a rotation angle position detection sensor or a rotation angle sensor. In the present embodiment, the rotation detection unit 70 is a resolver. The rotation detection unit 70 is, for example, a variable reluctance (VR) resolver.

As illustrated in FIGS. 3 and 4, the rotation detection unit 70 is housed in the sensor housing portion 10g. The rotation detection unit 70 is arranged on the bottom wall 10a. That is, the rotation detection unit 70 is arranged at the end on the other side in the axial direction of the stator housing portion 14. A central axis of the rotation detection unit 70 is arranged coaxially with the central axis J of the motor shaft 21. The rotation detection unit 70 includes a detected portion 71 and a sensor unit 72.

The detected portion 71 has an annular shape extending in the circumferential direction. The detected portion 71 is attached to the rotor 20. The detected portion 71 is attached to the motor shaft 21. The detected portion 71 is fitted and fixed to the motor shaft 21. The detected portion 71 is arranged at the end on the other side in the axial direction of the motor shaft 21. The detected portion 71 is made of a magnetic material. In the present embodiment, the rotation detection unit 70 is the resolver, and the detected portion 71 is a resolver rotor. The detected portion 71 is a rotating portion that rotates together with the rotor 20. The detected portion 71 is rotatable in the circumferential direction with respect to the sensor unit 72.

The sensor unit 72 has an annular shape extending in the circumferential direction. The sensor unit 72 is arranged on the radially outer side of the detected portion 71. The sensor unit 72 surrounds the detected portion 71 from the radially outer side. In the present embodiment, the rotation detection unit 70 is the resolver, and the sensor unit 72 is a resolver stator. The sensor unit 72 has a plurality of coils along the circumferential direction. The sensor unit 72 is a non-rotating portion that is fixed to the housing 10 and does not rotate.

The sensor unit 72 is attached to the stator housing portion 14. The sensor unit 72 is attached to the bottom wall 10a. The sensor unit 72 is fitted and fixed to the sensor housing portion 10g. As illustrated in FIG. 4, an outer circumferential surface of the sensor unit 72 is arranged to oppose an inner circumferential surface of the large-diameter portion 10i of the sensor housing portion 10g from the radially inner side. A surface of the sensor unit 72 facing the one side in the axial direction is in contact with the step portion 10j of the sensor housing portion 10g. The sensor unit 72 is supported by the step portion 10j from the one side in the axial direction. The sensor unit 72 is supported by the sensor cover 13 from the other side in the axial direction. That is, the sensor cover 13 supports the rotation detection unit 70 from the other side in the axial direction. The sensor unit 72 is sandwiched by the step portion 10j and the sensor cover 13 from the both sides in the axial direction Y.

The sensor cover 13 covers an opening on the other side in the axial direction of the sensor housing portion 10g. In the example of the present embodiment, the sensor cover 13 has a bottomed tubular shape. An end on the other side in the axial direction of a circumferential wall 13a of the sensor cover 13 is closed by a bottom wall 13b. An end on the one side in the axial direction of the circumferential wall 13a of the sensor cover 13 is open to the one side in the axial direction. A flange 13c is provided at the end on the one side in the axial direction of the circumferential wall 13a. The flange 13c is an annular shape that protrudes from the end on the one side in the axial direction of the circumferential wall 13a to the radially outer side and extends in the circumferential direction. A surface of the flange 13c facing the one side in the axial direction is in contact with a surface of the bottom wall 10a facing the other side in the axial direction and the sensor unit 72. The flange 13c is attached to the bottom wall 10a with a screw member or the like. Since the sensor cover 13 is attached to the bottom wall 10a, the rotation detection unit 70 (the sensor unit 72 thereof) is positioned and fixed in the axial direction Y with respect to the sensor housing portion 10g.

When the detected portion 71 rotates together with the motor shaft 21, an induced voltage corresponding to a circumferential position of the detected portion 71 is generated in the coil of the sensor unit 72. The sensor unit 72 detects the rotation of the detected portion 71 by detecting the induced voltage. As a result, the rotation detection unit 70 detects the rotation of the rotor 20 by detecting the rotation of the motor shaft 21. The rotation information of the rotor 20 detected by the rotation detection unit 70 is sent to the inverter 51 via a sensor wiring 73 to be described later.

As illustrated in FIGS. 3 to 6, the motor 1 includes the sensor wiring 73 that electrically connects the rotation detection unit 70 and the inverter 51. Note that FIG. 6 does not illustrate a part of the sensor wiring 73 but illustrates the sensor wiring 73 in a cross section for easy understanding of routing (arrangement) of the sensor wiring 73. As illustrated in FIG. 3, the sensor wiring 73 extends from the rotation detection unit 70. The sensor wiring 73 extends upward from the sensor unit 72 of the rotation detection unit 70. The sensor wiring 73 includes a first end 73a connected to the rotation detection unit 70 and a second end 73b connected to the inverter 51. The first end 73a is connected to the sensor unit 72. The second end 73b is connected to the first circuit board 51a, for example.

The sensor wiring 73 passes through the inside of the bottom wall 10a. For this reason, the sensor wiring 73 is easily routed. That is, since the sensor wiring 73 is routed through the bottom wall 10a, the sensor wiring 73 can be easily routed through a simple route without making the route for routing the wiring complicated or once leading out the wiring outside the motor, for example. As a result, the sensor wiring 73 can be optimally routed.

In addition, it is unnecessary to provide a chamber (housing portion) configured to route the sensor wiring 73 on the other side in the axial direction (that is, the outer side) of the bottom wall 10a. Therefore, the structure of the motor 1 can be simplified. In addition, the housing 10 can be easily manufactured since it is unnecessary to provide the chamber configured to route the sensor wiring 73 on the other side in the axial direction of the bottom wall 10a. That is, the housing 10 is easily casted while being formed as a single member having the stator housing portion 14 and the inverter housing portion 15. In addition, the rotation detection unit 70 can be easily arranged on the bottom wall 10a.

Since the sensor wiring 73 is easily routed and the structure of the motor 1 is simplified as described above, the ease of assembly of the motor 1 is improved. The motor 1 of the present embodiment is suitable as a so-called electromechanical motor.

The sensor wiring 73 passes through a portion on the inner side (the one side in the axial direction) instead of the outer side (the other side in the axial direction) of the bottom wall 10a. In the present embodiment, the sensor wiring 73 passes through the inside of the groove 10m. For this reason, the sensor wiring 73 is housed in the groove 10m, and the sensor wiring 73 can be prevented from coming in to contact another member (such as the coil 32) in the stator housing portion 14. In addition, the sensor wiring 73 extends along the groove 10m in the groove 10m. For this reason, the sensor wiring 73 is easily routed. That is, the sensor wiring 73 can be protected and easily routed.

In addition, the groove 10m extends on the surface on the one side in the axial direction of the bottom wall 10a in the direction connecting the rotation detection unit 70 and the inverter 51 in the present embodiment. As a result, the routing of the sensor wiring 73 can be optimized. In addition, the length of the sensor wiring 73 can be shortened.

As illustrated in FIGS. 5 and 6, the sensor wiring 73 is arranged close to or in contact with the groove bottom surface, which is located on the other side in the axial direction and faces the one side in the axial direction, of the inner surface of the groove 10m. For this reason, for example, the sensor wiring 73 can be easily attached and fixed to the groove bottom surface. The sensor wiring 73 is arranged at the center portion in the groove 10m in the width direction X. The sensor wiring 73 includes a plurality of types of wirings having different functions. The plurality of wirings included in the sensor wiring 73 are arrayed to be adjacent to each other in the width direction X and extend in the vertical direction Z.

In FIG. 3, the sensor wiring 73 is routed from the sensor unit 72 into the inverter housing portion 15 through the wiring passage hole 10k, the groove 10m, and the partition wall through-hole 10l. The sensor wiring 73 passes between the partition wall 10d and the capacitor 52. That is, the sensor wiring 73 passes a lower side of the capacitor 52 inside the inverter housing portion 15. As a result, the sensor wiring 73 can be easily routed. In addition, the length of the sensor wiring 73 can be shortened.

In addition, the partition wall 10d of the circumferential wall 10b includes the partition wall through-hole 10l through which the sensor wiring 73 passes in the present embodiment. In this case, the sensor wiring 73 can be more easily routed as the sensor wiring 73 passes through the inside of the bottom wall 10a and the partition wall through-hole 10l.

In addition, the partition wall through-hole 10l has the rectangular shape as viewed from the inverter housing portion 15 in the present embodiment. When the partition wall through-hole 10l has the rectangular shape in this manner, the length of the partition wall through-hole 10l in the axial direction Y (or the width direction X) can be easily reduced as compared with a case where the partition wall through-hole 10l has a square or circular shape, for example. As a result, a large space for passing the sensor wiring 73 can be secured without narrowing an arrangement space of electrical components such as the capacitor 52 provided in the inverter housing portion 15.

In addition, the periphery of the partition wall through-hole 10l is closed, which is different from a groove, for example. Therefore, as the sensor wiring 73 passes through the partition wall through-hole 10l, a range of movement caused by shaking (racking) or the like of the sensor wiring 73 is suppressed. As a result, the sensor wiring 73 can be prevented from coming into contact with the coil 32 of the stator 30, for example.

In the present embodiment, the corner of the partition wall through-hole 10l has the concave curved surface shape as viewed from the inverter housing portion 15. Therefore, the sensor wiring 73 can be prevented from being damaged even if the sensor wiring 73 is arranged and routed at the corner of the partition wall through-hole 101. Note that the same effect as described above can be obtained even when the partition wall through-hole 10l has an oval shape as viewed from the inverter housing portion 15.

In addition, the partition wall through-hole 10l is arranged at the center portion of the partition wall 10d in the width direction X in the present embodiment. For example, the dimension of the partition wall 10d in the vertical direction Z is likely to be smallest at the center portion in the width direction X as in the present embodiment. Therefore, the dimension of the partition wall through-hole 10l in the vertical direction Z can be easily reduced by arranging the partition wall through-hole 10l at the center portion of the partition wall 10d in the width direction X. In this case, the sensor wiring 73 easily passes through the partition wall through-hole 10l. In addition, it is possible to prevent a decrease in rigidity of the housing 10 caused by providing the partition wall through-hole 10l.

In addition, the motor 1 of the present embodiment includes the sensor housing portion 10g, which penetrates the bottom wall 10a in the axial direction Y and houses the rotation detection portion 70, and the sensor cover 13, which supports the rotation detection unit 70 from the other side in the axial direction, on the bottom wall 10a. In this case, the sensor housing portion 10g penetrates the bottom wall 10a in the axial direction Y, and the rotation detection unit 70 is attached to the sensor housing portion 10g from the other side in the axial direction. In addition, the rotation detection unit 70 can be pressed from the other side in the axial direction while covering the opening on the other side in the axial direction of the sensor housing portion 10g by the sensor cover 13. Therefore, the rotation detection unit 70 and the sensor cover 13 are assembled from the outer side (the other side in the axial direction) of the bottom wall 10a where workability is favorable. Then, the sensor cover 13 not only covers the rotation detection unit 70 from the other side in the axial direction and fixes the rotation detection unit 70 in the positioning state with respect to the sensor housing portion 10g by attaching the sensor cover 13 to the bottom wall 10a. Therefore, an attachment structure of the rotation detection unit 70 to the sensor housing portion 10g can be simplified.

In addition, in the present embodiment, the tubular first bearing holding portion 10c that protrudes from the bottom wall 10a toward the one side in the axial direction is provided, and the sensor wiring 73 passes through the wiring passage hole 10k penetrating the first bearing holding portion 10c in the radial direction. In this case, the sensor wiring 73 is connected to the inverter 51 from the rotation detection unit 70 through the wiring passage hole 10k, the inside of the bottom wall 10a (the groove 10m in the present embodiment), and the partition wall through-hole 10l. Therefore, the sensor wiring 73 can be easily routed. That is, the sensor wiring 73 passes through holes at both ends (front and rear) in the extending direction of the groove 10m, and thus, the sensor wiring 73 can be easily routed. In addition, the sensor wiring 73 hardly wobbles since the sensor wiring 73 passes through the holes at the both ends in the extending direction of the groove 10m.

In the present embodiment, the wiring passage hole 10k, the groove 10m, and the partition wall through-hole 101 are arranged continuously in the radial direction. As a result, the sensor wiring 73 can be easily routed.

In addition, the length in the axial direction Y and the length in the width direction X of the wiring passage hole 10k gradually increase from the inner circumferential surface to the outer circumferential surface of the circumferential wall of the first bearing holding portion 10c (that is, upward) in the present embodiment. In addition, the depth (groove depth) of the groove 10m in the axial direction Y gradually becomes deeper from the wiring passage hole 10k toward the partition wall through-hole 10l (that is, upward). In addition, the length in the axial direction Y and the length in the width direction X of the partition wall through-hole 10l gradually increase from the lower surface to the upper surface of the partition wall 10d.

In this case, the degree of freedom of wiring routing of the sensor wiring 73, which extends upward from the rotation detection unit 70, increases upward inside each of the wiring passage hole 10k, the groove 10m, and the partition wall through-hole 10l. Therefore, the sensor wiring 73 can enter the inside of inverter housing portion 15 from the inside of the stator housing portion 14 while being gently curved with a large curvature radius. As a result, the sensor wiring 73 can be prevented from being broken or damaged, and the sensor wiring 73 can be easily routed toward the inverter 51.

In addition, in the present embodiment, the three-phase coil wire 32a extending from the stator 30 is arranged inside the housing opening 10n of the housing 10, and the three-phase coil wire 32a is connected to the inverter 51 through the end on the one side in the axial direction of the partition wall 10d. That is, the sensor wiring 73 passes through the inside of the bottom wall 10a located at the end on the other side in the axial direction of the housing 10, and the three-phase coil wire 32a passes through the inside of the housing opening 10n located at the end on the one side in the axial direction of the housing 10.

In this case, the three-phase coil wire 32a led out from the stator 30 can be directly connected to the inverter 51. That is, a bus bar configured to connect the stator 30 and the inverter 51 is unnecessary, and the number of parts can be reduced.

In addition, when the stator 30 using no bus bar is attached to the stator housing portion 14, it is necessary to insert the stator 30 from the opening of the circumferential wall 10b toward the bottom wall 10a. That is, the stator 30 is inserted inside the circumferential wall 10b from the one side in the axial direction to the other side in the axial direction. In addition, the three-phase coil wire 32a is a highly rigid wire in the stator 30 using no bus bar, and it is difficult to easily bend the three-phase coil wire 32a like the sensor wiring 73. Therefore, making the three-phase coil wire 32a pass through the partition wall through-hole 10l or the like located at the end on the other side in the axial direction of the circumferential wall 10b becomes difficult work.

Therefore, it is preferable to arrange the three-phase coil wire 32a on the opposite side of the sensor wiring 73 in the axial direction Y as in the present embodiment. Since the three-phase coil wire 32a is arranged inside the housing opening 10n where workability is favorable due to the wide opening, not only the sensor wiring 73 described above but also the three-phase coil wire 32a can be easily routed, and the ease of assembly is improved.

In addition, the housing opening 10n of the housing 10 is covered with the cover member 12 in the present embodiment. In this case, the housing opening 10n is closed by the single cover member 12, and thus, the structure of the housing 10 is simplified, and the assembly workability is also excellent.

Note that the present invention is not limited to the above-described embodiment, and various modifications can be made within a scope not departing from a spirit of the present invention, for example, as described below.

Although the partition wall through-hole 10l has the rectangular shape or the oval shape as viewed from the inverter housing portion 15 in the above-described embodiment, the invention is not limited thereto. For example, the partition wall through-hole 10l may have a polygonal shape other than the rectangular shape, a circular shape, an elliptical shape, or a shape obtained by appropriately combining these shapes. For example, the shape of the partition wall through-hole 10l may be appropriately selected in accordance with the arrangement and component shapes of the electrical components such as the inverter 51 and the capacitor 52 housed in the inverter housing portion 15.

In addition, the wiring passage hole 10k has the rectangular shape or the oval shape, but the invention is not limited thereto. For example, the wiring passage hole 10k may have a polygonal shape other than the rectangular shape, a circular shape, an elliptical shape, or a shape obtained by appropriately combining these shapes.

In addition, the groove 10m has the groove bottom surface, the groove side surface, and the corner, but the invention is not limited thereto. The groove 10m may be, for example, a round groove shape in which the entire inner surface of the groove 10m is a concave curved surface.

In addition, the sensor wiring 73 passes through the inside of the groove 10m of the bottom wall 10a in the above-described embodiment, but the invention is not limited thereto. For example, a through-hole extending from the sensor housing portion 10g to the inverter housing portion 15 may be provided inside the bottom wall 10a, and the sensor wiring 73 may pass through the inside of the through-hole. In this case, the wiring passage hole 10k and the partition wall through-hole 10l are not necessarily provided.

In addition, the sensor wiring 73 passes through the lower side of the capacitor 52 in the inverter housing portion 15 in the above-described embodiment, but the invention is not limited thereto. For example, the sensor wiring 73 may pass through one side in the width direction or the other side in the width direction of the capacitor 52 inside the inverter housing portion 15. That is, the sensor wiring 73 extends toward the inverter 51 through the periphery of the capacitor 52 inside the inverter housing portion 15 in this case.

In addition, the rotation detection unit 70 is the resolver in the above-described embodiment, but the invention is not limited thereto. The rotation detection unit 70 may be a magnetic sensor such as an MR sensor having a magnetic resistance (MR) element, for example. In this case, the detected portion 71 is an MR sensor magnet. In addition, the sensor unit 72 is an MR sensor mounting board.

In addition, each configuration (constituent element) described in the above-described embodiment, modifications, and the writings may be combined within the scope not departing from the spirit of the present invention, and addition, omission, replacement, and other changes of the configuration are possible. In addition, the present invention is not limited by the above-described embodiment, and is limited only by the scope of the claims.

The present application claims the priority of Japanese Patent Application No. 2017-147111 filed on Jul. 28, 2017, the entire contents of which are hereby incorporated by reference.

1-9. (canceled)

10. A motor comprising:
a rotor having a motor shaft arranged along a central axis that extends in one direction;
a stator opposing the rotor with a gap in a radial direction;
an inverter electrically connected to the stator;
a housing having a stator housing portion that houses the stator and an inverter housing portion that houses the inverter;
a rotation detection unit detecting a rotation of the rotor; and
a sensor wiring electrically connecting the rotation detection unit and the inverter,
wherein the housing is a single member,
the stator housing portion has a bottomed tubular shape having a circumferential wall that is open on one side in an axial direction and a bottom wall provided at an end on another side in the axial direction of the circumferential wall,
an output end of the motor shaft protrudes from an opening of the circumferential wall toward the one side in the axial direction,
the rotation detection unit is arranged on the bottom wall, and
the sensor wiring passes through an inside of the bottom wall.

11. The motor according to claim 10, further comprising
a partition wall through-hole which penetrates the partition wall in the radial direction and through which the sensor wiring passes, the partition wall through-hole provided in a partition wall, located between the stator housing portion and the inverter housing portion, in the circumferential wall,
wherein the inverter housing portion is located on a radially outer side of the stator housing portion.

12. The motor according to claim 11, wherein
the partition wall through-hole has a rectangular shape as viewed from the inverter housing portion.

13. The motor according to claim 11, wherein
the partition wall through-hole has an oval shape as viewed from the inverter housing portion.

14. The motor according to claim 10, wherein
the bottom wall has a groove that is recessed from the one side to the other side in the axial direction, and
the sensor wiring passes through an inside of the groove.

15. The motor according to claim 10, further comprising
a capacitor housed in the inverter housing portion and electrically connected to the inverter,
wherein the inverter housing portion is located on the radially outer side of the stator housing portion, and
the sensor wiring passes between a partition wall, located between the stator housing portion and the inverter housing portion, in the circumferential wall and the capacitor.

16. The motor according to claim 11, further comprising
a capacitor housed in the inverter housing portion and electrically connected to the inverter,
wherein the inverter housing portion is located on the radially outer side of the stator housing portion, and
the sensor wiring passes between a partition wall, located between the stator housing portion and the inverter housing portion, in the circumferential wall and the capacitor.

17. The motor according to claim 12, further comprising
a capacitor housed in the inverter housing portion and electrically connected to the inverter,
wherein the inverter housing portion is located on the radially outer side of the stator housing portion, and
the sensor wiring passes between a partition wall, located between the stator housing portion and the inverter housing portion, in the circumferential wall and the capacitor.

18. The motor according to claim 13, further comprising
a capacitor housed in the inverter housing portion and electrically connected to the inverter,
wherein the inverter housing portion is located on the radially outer side of the stator housing portion, and
the sensor wiring passes between a partition wall, located between the stator housing portion and the inverter housing portion, in the circumferential wall and the capacitor.

19. The motor according to claim 14, further comprising
a capacitor housed in the inverter housing portion and electrically connected to the inverter,
wherein the inverter housing portion is located on the radially outer side of the stator housing portion, and
the sensor wiring passes between a partition wall, located between the stator housing portion and the inverter housing portion, in the circumferential wall and the capacitor.

20. The motor according to claim 10, wherein
the bottom wall comprises:
a sensor housing portion that penetrates the bottom wall in the axial direction and houses the rotation detection unit; and
a sensor cover that covers an opening on the other side in the axial direction of the sensor housing portion and supports the rotation detection unit from the other side in the axial direction.

21. The motor according to claim 10, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

22. The motor according to claim 11, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

23. The motor according to claim 12, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

24. The motor according to claim 13, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

25. The motor according to claim 14, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

26. The motor according to claim 15, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

27. The motor according to claim 16, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

28. The motor according to claim 17, further comprising:
a first bearing rotatably supporting an end on the other side in the axial direction of the motor shaft;
a tubular first bearing holding portion protruding from the bottom wall toward the one side in the axial direction and holding the first bearing; and
a wiring passage hole which penetrates the first bearing holding portion in the radial direction and through which the sensor wiring passes.

29. The motor according to claim 10, wherein
the inverter housing portion is located on the radially outer side of the stator housing portion,
the circumferential wall has a partition wall located between the stator housing portion and the inverter housing portion,
a housing opening through which at least a part of the stator, an end on the one side in the axial direction of the partition wall, and at least a part of the inverter housing portion are exposed is provided at an end on the one side in the axial direction of the housing,
a three-phase coil wire extending from the stator is arranged inside the housing opening, and
the three-phase coil wire is connected to the inverter through the end on the one side in the axial direction of the partition wall.
